(19) United States
(12) Patent Application Publication
(10) Pub. No.: US 2016/0171761 A1
(43) Pub. Date: Jun. 16, 2016

(54) COMPUTING DEVICE AND METHOD FOR PATCHING POINT CLOUDS OF OBJECT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN-YUAN WU, Shenzhen (CN); PENG XIE, Shenzhen (CN); HENG ZHANG, Shenzhen (CN); CHIH-KUANG CHANG, New Taipei (TW)

(21) Appl. No.: 14/726,793

(22) Filed: Jun. 1, 2015

(30) Foreign Application Priority Data
Dec. 16, 2014 (CN) 201410774967.5

(51) Int. Cl. G06T 17/20

(52) U.S. Cl. CPC G06T 17/20; G06T 2200/04

(57) ABSTRACT

A computing device and a method for patching point clouds of an object are provided. A point cloud of the object is acquired from a storage device of the computing device, and the point cloud is triangulated using several triangles. The method identifies a void in the point cloud to be patched, and obtains one or more triangles according to one or more included angles of neighboring sides of the void of the point cloud. The void of the point cloud is filled with the one or more obtained triangles. The filled triangles are adjusted according to normal vectors of the filled triangles, and the point cloud is rendered on the display screen.

### CROSS-REFERENCE TO RELATED APPLICATIONS

This application claims priority to Chinese Patent Application No. 201410774967.5 filed on Dec. 16, 2014, the contents of which are incorporated by reference herein.

### FIELD

The subject matter herein generally relates to point clouds technology, and particularly to a computing device and a method for patching point clouds of an object.

### BACKGROUND

A scanning device can measure a plurality of points to generate point clouds by scanning a surface of an object (e.g., a component of a mobile phone). Voids may occur in places of a point cloud due to an external interference during the scanning of the object or a problem of the scanning device itself occurring during the scan. The voids need to be patched for subsequent use using a filling algorithm. However, because of complicated shapes and different sizes of the voids, the filling algorithm usually cannot make up the missed points of the point cloud at their intended positions and a distortion of the point cloud may be resulted due to the patching.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device including a point cloud patch system.

FIG. 2 is a block diagram of one embodiment of function modules of the point cloud patch system in the computing device in FIG. 1.

FIG. 3 is a flowchart of an example embodiment of a method for patching a point cloud of an object.

FIGS. 4A-4C are diagrams of different angles between two neighboring sides of voids of the point cloud.

FIG. 5 is a diagram for adjusting a filled triangle of voids of the point cloud.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series, and the like.

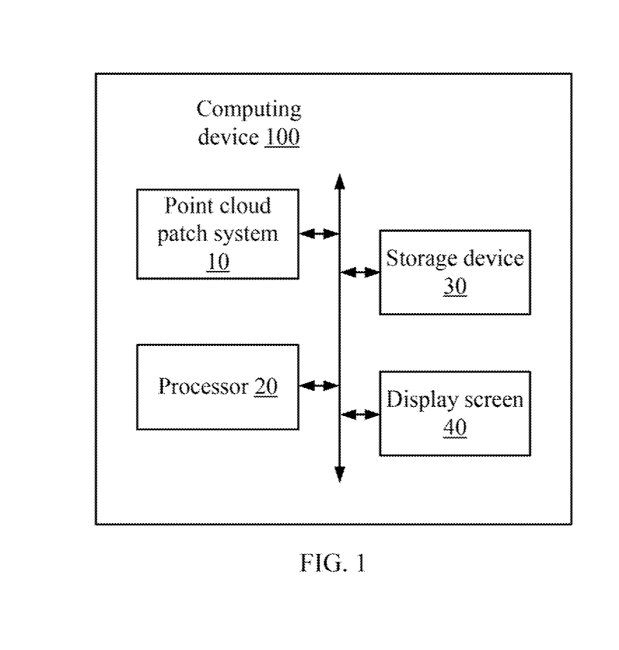

FIG. 1 illustrates a block diagram of an example embodiment of a computing device 100. In at least one embodiment, the computing device 100 can be, but is not limited to, a tablet computer, a server, a personal computer, a programmable logic controller (PLC), a measurement machine (e.g., a computerized numerical control (CNC) machine) or any other electronic device which has calculation capability. FIG. 1 illustrates only one example of the computing device 100, and other examples can comprise more or fewer components than those shown in the embodiment, or have a different configuration of the various components.

In at least one embodiment, as shown in FIG. 1, the computing device 100 can include, but is not limited to, a point cloud patch system 10, at least one processor 20, a storage device 30, and a display screen 40. The at least one processor 20 executes one or more computerized codes and other applications of the computing device 100 to provide functions of the point cloud patch system 10. The storage device 30 can be an internal storage device, such as a random access memory (RAM) for temporary storage of information, and/or a read only memory (ROM) for permanent storage of information. The storage device 30 can also be an external storage device, such as an external hard disk, a storage card, or a data storage medium. The display screen 40 can display any visualized data of the computing device 100.

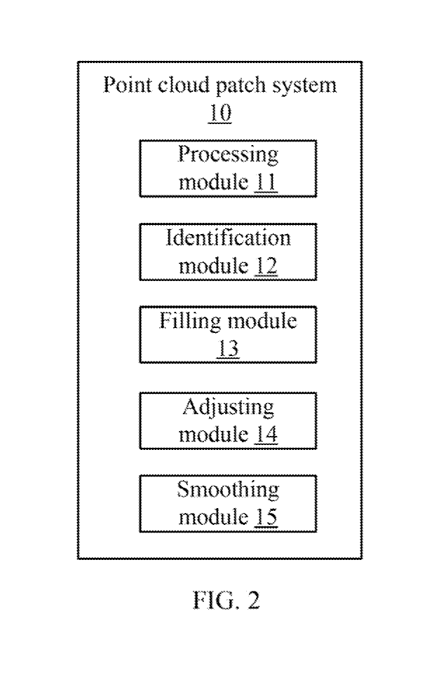

FIG. 2 is a block diagram of one embodiment of function modules of the point cloud patch system 10. In at least one embodiment, the point cloud patch system 10 can include, but is not limited to, a processing module 11, an identification module 12, a filling module 13, an adjusting module 14, and a smoothing module 15. The modules 11-15 can include computerized instructions in the form of one or more computer-readable programs that can be stored in a non-transitory computer-readable medium, such as the storage device 30, and be executed by the at least one processor 20 of the computing device 100.

The processing module 11 is configured to acquire a point cloud of an object from the storage device 30, and triangulate the point cloud using a plurality of triangles. In at least one embodiment, the point cloud can be represented by the plurality of triangles after triangulation. In at least one embodiment, the point cloud can be a set of points representing the external surface of the object. The object can be, but is not limited to, a component (e.g., a shell) of an electronic device (e.g., a mobile phone). In at least one embodiment, the point cloud includes data of, but not limited to, three dimensional coordinates of points of the point cloud, identifications of the points and a total number of the points. The point cloud can be obtained from a database in the storage device 30 or a three-dimensional scanner which is scanning the object.

The identification module 12 is configured to identify a void in the point cloud that needs to be patched. In at least one embodiment, the void in the point cloud to be patched can be identified based on a predetermined characteristic of the point cloud. The predetermined characteristic can be, but is not limited to, sides of the void located on a single triangle of the point cloud.

In at least one embodiment, the identification module 12 traverses each side of the plurality of triangles of the point cloud, and confirms sides of the plurality of triangles located on a single triangle of the point cloud. When the confirmed sides of the plurality of triangles generate an enclosed area of the point cloud, the identification module 12 determines that the enclosed area of the point cloud is the void to be patched.

The filling module 13 is configured to obtain one or more triangles to patch the void according to one or more included angles of neighboring sides of the void of the point cloud, and fill the void of the point cloud with the one or more obtained triangles.

In at least one embodiment, the filling module 13 can define a first predetermined value and a second predetermined value for obtaining the one or more triangles to patch the void, and determine a plurality of intervals according to the first and second predetermined values. The first predetermined value (e.g., 90°) is less than the second predetermined value (e.g.,) 180°. The first predetermined value and the second predetermined value are preset by a user or by the point cloud patch system 10. Three intervals are determined by the first and second predetermined values, and the three intervals can be a first interval, a second interval, and a third interval. The first interval is less than or equal to the first predetermined value, the second interval is greater than the first predetermined value and is less than or equal to the second predetermined value, and the third interval is greater than the second predetermined value. In addition, three or more predetermined values (e.g., four predetermined values) are available for obtaining the one or more triangles to patch the void.

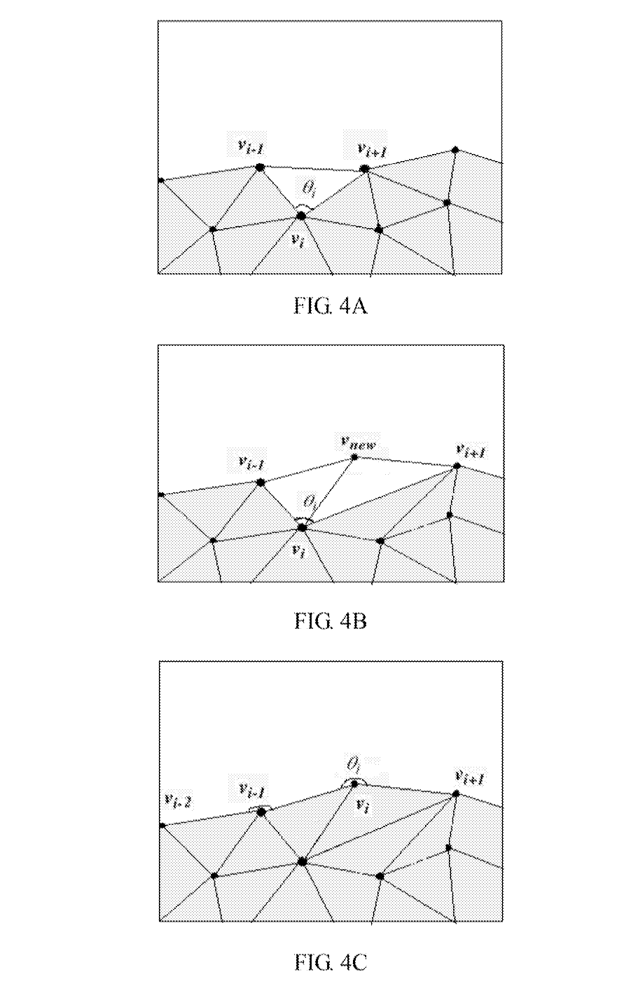

In at least one embodiment, the filling module 13 further calculates an included angle of two neighboring sides of the void, and determines an interval the included angle of the two neighboring sides of the void belongs to. In at least one embodiment, when the included angle of the two neighboring sides of the void is in the first interval, two vertices of the neighboring sides of the void on different sides are joined to obtain a triangle for patching the void by the filling module 13. As an example shown in FIG. 4A, an included angle “θᵢ” of two neighboring sides “vᵢvᵢ₋₁” and “vᵢvᵢ₊₁” of the void is in the first interval, and two vertices “vᵢ₋₁” and “vᵢ₊₁” of the two neighboring sides “vᵢvᵢ₋₁” and “vᵢvᵢ₊₁” on different sides are joined to obtain a triangle “vᵢvᵢ₋₁vᵢ₊₁” for patching the void by the filling module 13.

In at least one embodiment, when the included angle of the two neighboring sides of the void is in the second interval, the filling module 13 constructs a bi-section of the included angle of the two neighboring sides of the void, and joins the endpoint of the bi-section with two vertices of the neighboring sides of the void on different sides separately to obtain two triangles for patching the void. The endpoint of the bi-section is a point that does not overlap with the vertex of the included angle of the two neighboring sides of the void. The length of the bi-section is an average of the length of the two neighboring sides of the void. As an example shown in FIG. 4B, the included angle “θᵢ” of the two neighboring sides “vᵢvᵢ₋₁” and “vᵢvᵢ₊₁” is in the second interval, the filling module 13 constructs a bi-section “vᵢv_{new}” of the included angle “θᵢ”, joins the endpoint “v_{new}” of the bi-section “vᵢv_{new}” with the two vertices “vᵢ₋₁” and “vᵢ₊₁” of the two neighboring sides “vᵢvᵢ₋₁” and “vᵢvᵢ₊₁” on different sides separately, and obtains two triangles “Δvᵢvᵢ₋₁v_{new}” and “Δvᵢvᵢ₊₁v_{new}” for patching the void. The length of the bi-section “vᵢv_{new}” is an average of the length of the neighboring sides “vᵢvᵢ₋₁” and “vᵢvᵢ₊₁”.

In at least one embodiment, when the included angle of the two neighboring sides of the void is in the third interval, the filling module 13 keeps the two neighboring sides of the void unchanged. That is, the filling module 13 does nothing with the two neighboring sides of the void, and no triangles are obtained for patching the void. As an example shown in FIG. 4C, the included angle “θᵢ” of the two neighboring sides “vᵢvᵢ₋₁” and “vᵢvᵢ₊₁” is in the third interval, the filling module 13 does nothing with the two neighboring sides “vᵢvᵢ₋₁” and “vᵢvᵢ₊₁”, and no triangles are obtained for patching the void.

In at least one embodiment, the filling module 13 continuously determines the included angles of neighboring sides of the void, and obtains triangles for patching the void until a single triangle is left on three sides of the void.

The adjusting module 14 is configured to adjust the filled triangles according to normal vectors of the filled triangles to keep the filled triangles in accordance with surrounding triangles in shape features. In at least one embodiment, the filled triangles which are obtained when the included angle of the two neighboring sides of the void is in the first interval do not need to be adjusted. The filled triangles which are obtained when the included angle of the two neighboring sides of the void is in the second interval need to be adjusted by the adjusting module 14.

In at least one embodiment, the adjusting module 14 obtains the bi-section of the included angle of the two neighboring sides of the void, calculates a normal vector of the starting point of the bi-section. The starting point of the bi-section is a point that overlaps with the vertex of the included angle of the two neighboring sides of the void. The normal vector of the starting point “vᵢ” of the bi-section “vᵢv_{new}” shown in FIG. 4B can be calculated as follows. For example, if proximal points of “vᵢ” is represented as “Sᵢ”, and “Sᵢ” includes a number of “n” points. A centre of mass of “Sᵢ” is represented as

$$“ {\overline{v}}_{i} = \frac{{\sum }_{j ∈ {S}_{i}} {v}_{j}}{\vert {S}_{i} \vert} ” ,$$

and a covariance matrix of “Sᵢ” is represented as “C=[vⱼ₁−v̅ᵢ, . . . , vⱼₙ−v̅ᵢ]*[vⱼ₁−v̅ᵢ, . . . , vⱼₙ−v̅ᵢ]^{T}, jεSᵢ”. The adjusting module 14 determines an eigenvector of a smallest eigenvalue of “C” as the normal vector of “vᵢ”.

In at least one embodiment, the adjusting module 14 further calculates normal vectors of the two triangles related to the bi-section. The two triangles related to the bi-section are the two triangles obtained by joining the endpoint of the bi-section with two vertices of the neighboring sides of the void on different sides separately. As the example shown in FIG. 4B, the normal vectors “n1” and “n2” of the two triangles “Δvᵢvᵢ₋₁v_{new}” and “Δvᵢvᵢ₊₁v_{new}” related to the bi-section “vᵢv_{new}” can be calculated as follows. For example, if three vertices of a triangle can be represented as “v0”, “v1”, and “v2”, then a normal vector of the triangle can be calculated by using the following formulas of “n.x=(v1.y−v0.y)*(v2.z−v0.z)−(v1.z−v0.z)*(v2.y−v0.y)”, “n.y=(v1.z−v0.z)*(v2.x−v0.x)−(v1.x−v0.x)*(v2.z−v0.z)”, and “n.z=(v1.x−v0.x)*(v2.y−v0.y)−(v1.y−v0.y)*(v2.x−v0.x)”, where x, y and z represent coordinate values of the vertices “v0”, “v1”, and “v2”.

In at least one embodiment, the adjusting module 14 obtains an angle to be rotated by the bi-section according to the normal vector of the starting point of the bi-section and the normal vectors of the two triangles related to the bi-section, and obtains two adjusted triangles according to the rotated angle of the bi-section. In at least one embodiment, when the rotated angle of the bi-section is greater than zero, the bi-section is rotated upward to an absolute value of the rotated angle of the bi-section corresponding to the plane of the two triangles related to the bi-section by the adjusting module 14. When the rotated angle of the bi-section is less than zero, the bi-section is rotated downward to the absolute value of the rotated angle of the bi-section corresponding to the plane of the two triangles related to the bi-section by the adjusting module 14. When the rotated angle of the bi-section is equal to zero, the bi-section is kept unchanged by the adjusting module 14. The adjusting module 14 obtains two adjusted triangles by joining the endpoint of the adjusted bi-section with the two vertices of the two neighboring sides of the void on different sides separately. The endpoint of the adjusted bi-section is a point that does not overlap with the vertex of the included angle of the two neighboring sides of the void.

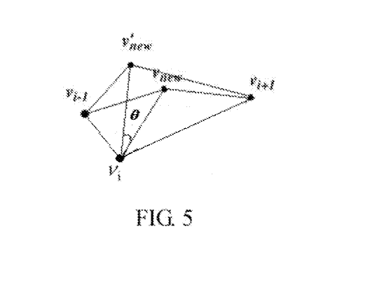

As an example shown in FIG. 5, the rotated angle “θ” of the bi-section “vᵢv_{new}” can be obtained by calculation using a formula of “θ=arctan(n0−½*n1−½*n2)”. When the rotated angle “θ” of the bi-section “vᵢv_{new}” is greater than zero, the bi-section “vᵢv_{new}” is rotated upward to an angle of “|θ|” corresponding to the plane of the two triangles “Δvᵢvᵢ₋₁v_{new}” and “Δvᵢvᵢ₊₁v_{new}”. When the rotated angle “θ” of the bi-section “vᵢv_{new}” is less than zero, the bi-section “vᵢv_{new}” is rotated downward to an angle of “|θ|” corresponding to the plane of the two triangles “Δvᵢvᵢ₋₁v_{new}” and “Δvᵢvᵢ₊₁v_{new}”. Two adjusted triangles “Δvᵢvᵢ₋₁v′_{new}” and “Δvᵢvᵢ₊₁v′_{new}” are obtained by joining the endpoint “v′_{new}” of the adjusted bi-section “vᵢv′_{new}” with the two vertices “vᵢ₋₁” and “vᵢ₊₁” of the two neighboring sides “vᵢvᵢ₋₁” and “vᵢvᵢ₊₁” of the void on different sides separately.

The smoothing module 15 is configured to smooth the patched point cloud, and output the patched point cloud to be displayed on the display screen 40. In at least one embodiment, the smoothing module 15 uses a preset smoothing method to smooth the patched point cloud. In at least one embodiment, the preset smoothing method can be, but is not limited to, moving along the directions of normal vectors of filled points in the void until the filled points satisfy a required accuracy of smoothness. The required accuracy of smoothness can be set up by the user or the point cloud patch system 10. The filled points in the void are endpoints of adjusted bi-sections in the void.

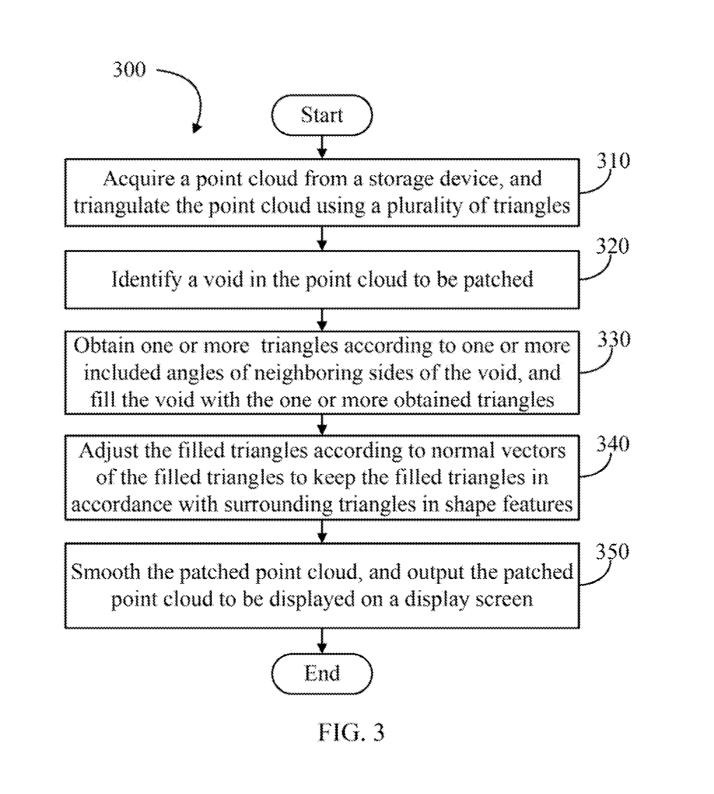

FIG. 3 illustrates a flowchart of an example embodiment of a method for patching a point cloud. In an example embodiment, the method is performed by execution of computer-readable software program codes or instructions by at least one processor of a computing device.

Referring to FIG. 3, a flowchart is presented in accordance with an example embodiment. The method 300 is provided by way of example, as there are a variety of ways to carry out the method. The method 300 described below can be carried out using the configurations illustrated in FIG. 1 and FIG. 2, for example, and various elements of the figure are referenced in explaining example method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks can be utilized without departing from this disclosure. The example method 300 can begin at block 310.

At block 310, a processing module acquires a point cloud of an object from a storage device of the computing device, and triangulates the point cloud using a plurality of triangles. In at least one embodiment, the point cloud can be represented by the plurality of triangles after triangulation. In at least one embodiment, the point cloud can be a set of points representing the external surface of the object. The object can be, but is not limited to, a component (e.g., a shell) of an electronic device (e.g., a mobile phone). In at least one embodiment, the point cloud includes data of, but not limited to, three dimensional coordinates of points of the point cloud, identifications of the points and a total number of the points. The point cloud can be obtained from a database in the storage device or a three-dimensional scanner which is scanning the object.

At block 320, an identification module identifies a void in the point cloud that needs to be patched. In at least one embodiment, the void in the point cloud to be patched can be identified based on a predetermined characteristic of the point cloud. The predetermined characteristic can be, but is not limited to, sides of the void located on a single triangle of the point cloud.

In at least one embodiment, the identification module traverses each side of the plurality of triangles of the point cloud, and confirms sides of the plurality of triangles located on a single triangle of the point cloud. When the confirmed sides of the plurality of triangles generate an enclosed area of the point cloud, the identification module determines the enclosed area of the point cloud as the void to be patched.

At block 330, a filling module obtains one or more triangles to patch the void according to one or more included angles of neighboring sides of the void of the point cloud, and fills the void of the point cloud with the one or more obtained triangles.

In at least one embodiment, the filling module can define a first predetermined value and a second predetermined value for obtaining the one or more triangles to patch the void, and determine a plurality of intervals according to the first and second predetermined values. The first predetermined value (e.g., 90°) is less than the second predetermined value (e.g., 180°). The first predetermined value and the second predetermined value are preset by a user or by a point cloud patch system of the computing device. Three intervals are determined by the first and second predetermined values, and the three intervals can be a first interval, a second interval, and a third interval. The first interval is less than or equal to the first predetermined value, the second interval is greater than the first predetermined value and is less than or equal to the second predetermined value, and the third interval is greater than the second predetermined value. In addition, three or more predetermined values (e.g., four predetermined values) are available for obtaining the one or more triangles to patch the void.

In at least one embodiment, the filling module further calculates an included angle of two neighboring sides of the void, and determines an interval the included angle of the two neighboring sides of the void belongs to. In at least one embodiment, when the included angle of the two neighboring sides of the void is in the first interval, two vertices of the neighboring sides of the void on different sides are joined to obtain a triangle for patching the void by the filling module. In at least one embodiment, when the included angle of the two neighboring sides of the void is in the second interval, the filling module constructs a bi-section of the included angle of the two neighboring sides of the void, and joins the endpoint of the bi-section with two vertices of the neighboring sides of the void on different sides separately to obtain two triangles for patching the void. The endpoint of the bi-section is a point that does not overlap with the vertex of the included angle of the two neighboring sides of the void. The length of the bi-section is an average of the length of the two neighboring sides of the void. In at least one embodiment, when the included angle of the two neighboring sides of the void is in the third interval, the filling module keeps the two neighboring sides of the void unchanged. That is, the filling module does nothing with the two neighboring sides of the void, and no triangles are obtained for patching the void. In at least one embodiment, the filling module continuously determines the included angles of neighboring sides of the void, and obtains triangles for patching the void until a single triangle is left on three sides of the void.

At block 340, an adjusting module adjusts the filled triangles according to normal vectors of the filled triangles to keep the filled triangles in accordance with surrounding triangles in shape features. In at least one embodiment, the filled triangles which are obtained when the included angle of the two neighboring sides of the void is in the first interval do not need to be adjusted. The filled triangles which are obtained when the included angle of the two neighboring sides of the void is in the second interval need to be adjusted by the adjusting module.

In at least one embodiment, the adjusting module obtains the bi-section of the included angle of the two neighboring sides of the void, calculates a normal vector of the starting point of the bi-section. The starting point of the bi-section is a point that overlaps with the vertex of the included angle of the two neighboring sides of the void. In at least one embodiment, the adjusting module further calculates normal vectors of the two triangles related to the bi-section. The two triangles related to the bi-section are the two triangles obtained by joining the endpoint of the bi-section with two vertices of the neighboring sides of the void on different sides separately. In at least one embodiment, the adjusting module obtains an angle to be rotated by the bi-section according to the normal vector of the starting point of the bi-section and the normal vectors of the two triangles related to the bi-section, and obtains two adjusted triangles according to the rotated angle of the bi-section.

In at least one embodiment, when the rotated angle of the bi-section is greater than zero, the bi-section is rotated upward to an absolute value of the rotated angle of the bi-section corresponding to the plane of the two triangles related to the bi-section by the adjusting module. When the rotated angle of the bi-section is less than zero, the bi-section is rotated downward to the absolute value of the rotated angle of the bi-section corresponding to the plane of the two triangles related to the bi-section by the adjusting module. When the rotated angle of the bi-section is equal to zero, the bi-section is kept unchanged by the adjusting module. The adjusting module obtains two adjusted triangles by joining the endpoint of the adjusted bi-section with the two vertices of the two neighboring sides of the void on different sides separately. The endpoint of the adjusted bi-section is a point that does not overlap with the vertex of the included angle of the two neighboring sides of the void.

At block 350, a smoothing module smoothes the patched point cloud, and outputs the patched point cloud to be displayed on a display screen of the computing device. In at least one embodiment, the smoothing module uses a preset smoothing method to smooth the patched point cloud. In at least one embodiment, the preset smoothing method can be, but is not limited to, moving along the directions of normal vectors of filled points in the void until the filled points satisfy a required accuracy of smoothness. The required accuracy of smoothness can be set up by the user or the point cloud patch system. The filled points in the void are endpoints of adjusted bi-sections in the void.

All of the processes described above can be embodied in, and fully automated via, functional code modules executed by one or more general purpose processors such as the processor. The functional code modules can be stored in any type of non-transitory readable medium or other storage device such as the storage device. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications can be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computing device comprising:
a display screen;
at least one processor; and
a storage device that stores one or more programs which, when executed by the at least one processor, cause the at least one processor to:
acquire a point cloud of an object from the storage device;
triangulate the point cloud using a plurality of triangles;
identify a void in the point cloud to be patched;
obtain one or more triangles according to one or more included angles of neighboring sides of the void of the point cloud;
fill the void of the point cloud with the one or more obtained triangles;
adjust the filled triangles of the void of the point cloud according to normal vectors of the filled triangles; and
render on the display screen the point cloud.

2. The computing device of claim 1, wherein the one or more programs further cause the at least one processor to:
smooth the point cloud to be displayed on the display screen.

3. The computing device of claim 1, wherein the void in the point cloud to be patched is identified based on a predetermined characteristic of the point cloud, and wherein the predetermined characteristic is sides of the void located on a single triangle of the point cloud.

4. The computing device of claim 1, wherein the void in the point cloud to be patched is identified according to the point cloud by:
traversing each side of the plurality of triangles of the point cloud;
confirming sides of the plurality of triangles located on a single triangle of the point cloud; and
determining an enclosed area of the point cloud as the void to be patched when the confirmed sides of the plurality of triangles generate the enclosed area of the point cloud.

5. The computing device of claim 1, wherein the one or more triangles are obtained by:
defining a first predetermined value and a second predetermined value for obtaining the one or more triangles to patch the void;
determining a first interval that is less than or equal to the first predetermined value, a second interval that is greater than the first predetermined value and is less than or equal to the second predetermined value, and a third interval that is greater than the second predetermined value;
calculating an included angle of two neighboring sides of the void;
determining an interval the included angle of the two neighboring sides of the void belongs to;
joining two vertices of the neighboring sides of the void on different sides to obtain a triangle for patching the void when the included angle of the two neighboring sides of the void is in the first interval;
constructing a bi-section of the included angle of the two neighboring sides of the void, and joining the endpoint of the bi-section with two vertices of the neighboring sides of the void on different sides separately to obtain two triangles for patching the void when the included angle of the two neighboring sides of the void is in the second interval;
keeping the two neighboring sides of the void unchanged when the included angle of the two neighboring sides of the void is in the third interval; and
determining the included angles of neighboring sides of the void, and obtaining triangles for patching the void until a single triangle is left on three sides of the void.

6. The computing device of claim 5, wherein the filled triangles obtained when the included angle of the two neighboring sides of the void is in the second interval are adjusted by:
obtaining the bi-section of the included angle of the two neighboring sides of the void;
calculating a normal vector of the starting point of the bi-section;
calculating normal vectors of the two triangles related to the bi-section;
obtaining an angle to be rotated by the bi-section according to the normal vector of the starting point of the bi-section and the normal vectors of the two triangles related to the bi-section; and
obtaining two adjusted triangles according to the rotated angle of the bi-section.

7. The computing device of claim 6, wherein the bi-section is rotated upward to an absolute value of the rotated angle of the bi-section corresponding to the plane of the two triangles related to the bi-section when the rotated angle of the bi-section is greater than zero, wherein the bi-section is rotated downward to the absolute value of the rotated angle of the bi-section corresponding to the plane of the two triangles related to the bi-section when the rotated angle of the bi-section is less than zero, and wherein the bi-section is kept unchanged when the rotated angle of the bi-section is equal to zero.

8. A computer-implemented method for patching point clouds of an object using a computing device and executed by at least one processor of the computing device, the method comprising:
acquiring, from a storage device of the computing device, a point cloud of the object;
triangulating the point cloud using a plurality of triangles;
identifying a void in the point cloud to be patched;
obtaining one or more triangles according to one or more included angles of neighboring sides of the void of the point cloud;
filling the void of the point cloud with the one or more obtained triangles;
adjusting, according to normal vectors of the filled triangles, the filled triangles of the void of the point cloud; and
rendering on a display screen of the computing device the point cloud.

9. The method of claim 8, further comprising:
smoothing the point cloud to be displayed on the display screen.

10. The method of claim 8, wherein the void in the point cloud to be patched is identified based on a predetermined characteristic of the point cloud, and wherein the predetermined characteristic is sides of the void located on a single triangle of the point cloud.

11. The method of claim 8, wherein the void in the point cloud to be patched is identified according to the point cloud by:
traversing each side of the plurality of triangles of the point cloud;
confirming sides of the plurality of triangles located on a single triangle of the point cloud; and
determining an enclosed area of the point cloud as the void to be patched when the confirmed sides of the plurality of triangles generate the enclosed area of the point cloud.

12. The method of claim 8, wherein the one or more triangles are obtained by:
defining a first predetermined value and a second predetermined value for obtaining the one or more triangles to patch the void;
determining a first interval that is less than or equal to the first predetermined value, a second interval that is greater than the first predetermined value and is less than or equal to the second predetermined value, and a third interval that is greater than the second predetermined value;
calculating an included angle of two neighboring sides of the void;
determining an interval the included angle of the two neighboring sides of the void belongs to;
joining two vertices of the neighboring sides of the void on different sides to obtain a triangle for patching the void when the included angle of the two neighboring sides of the void is in the first interval;
constructing a bi-section of the included angle of the two neighboring sides of the void, and joining the endpoint of the bi-section with two vertices of the neighboring sides of the void on different sides separately to obtain two triangles for patching the void when the included angle of the two neighboring sides of the void is in the second interval;
keeping the two neighboring sides of the void unchanged when the included angle of the two neighboring sides of the void is in the third interval; and
determining the included angles of neighboring sides of the void, and obtaining triangles for patching the void until a single triangle is left on three sides of the void.

13. The method of claim 12, wherein the filled triangles obtained when the included angle of the two neighboring sides of the void is in the second interval are adjusted by:
obtaining the bi-section of the included angle of the two neighboring sides of the void;
calculating a normal vector of the starting point of the bi-section;
calculating normal vectors of the two triangles related to the bi-section;
obtaining an angle to be rotated by the bi-section according to the normal vector of the starting point of the bi-section and the normal vectors of the two triangles related to the bi-section; and
obtaining two adjusted triangles according to the rotated angle of the bi-section.

14. The method of claim 13, wherein the bi-section is rotated upward to an absolute value of the rotated angle of the bi-section corresponding to the plane of the two triangles related to the bi-section when the rotated angle of the bi-section is greater than zero, wherein the bi-section is rotated downward to the absolute value of the rotated angle of the bi-section corresponding to the plane of the two triangles related to the bi-section when the rotated angle of the bi-section is less than zero, and wherein the bi-section is kept unchanged when the rotated angle of the bi-section is equal to zero.

15. A non-transitory computer-readable medium having stored thereon instructions that, when executed by at least one processor of a computing device, causing the computing device to perform a method for patching point clouds of an object, the method comprises:
acquiring, from a storage device of the computing device, a point cloud of the object;
triangulating the point cloud using a plurality of triangles;
identifying a void in the point cloud to be patched;
obtaining one or more triangles according to one or more included angles of neighboring sides of the void of the point cloud;
filling the void of the point cloud with the one or more obtained triangles;
adjusting, according to normal vectors of the filled triangles, the filled triangles of the void of the point cloud; and
rendering on a display screen of the computing device the point cloud.

16. The non-transitory computer-readable medium of claim 15, wherein the method further comprises:
smoothing the point cloud to be displayed on the display screen.

17. The non-transitory computer-readable medium of claim 15, wherein the void in the point cloud to be patched is identified based on a predetermined characteristic of the point cloud, and wherein the predetermined characteristic is sides of the void located on a single triangle of the point cloud.

18. The non-transitory computer-readable medium of claim 15, wherein the one or more triangles are obtained by:
defining a first predetermined value and a second predetermined value for obtaining the one or more triangles to patch the void;
determining a first interval that is less than or equal to the first predetermined value, a second interval that is greater than the first predetermined value and is less than or equal to the second predetermined value, and a third interval that is greater than the second predetermined value;
calculating an included angle of two neighboring sides of the void;
determining an interval the included angle of the two neighboring sides of the void belongs to;
joining two vertices of the neighboring sides of the void on different sides to obtain a triangle for patching the void when the included angle of the two neighboring sides of the void is in the first interval;
constructing a bi-section of the included angle of the two neighboring sides of the void, and joining the endpoint of the bi-section with two vertices of the neighboring sides of the void on different sides separately to obtain two triangles for patching the void when the included angle of the two neighboring sides of the void is in the second interval;
keeping the two neighboring sides of the void unchanged when the included angle of the two neighboring sides of the void is in the third interval; and
determining the included angles of neighboring sides of the void, and obtaining triangles for patching the void until a single triangle is left on three sides of the void.

19. The non-transitory computer-readable medium of claim 18, wherein the filled triangles obtained when the included angle of the two neighboring sides of the void is in the second interval are adjusted by:
obtaining the bi-section of the included angle of the two neighboring sides of the void;
calculating a normal vector of the starting point of the bi-section;
calculating normal vectors of the two triangles related to the bi-section;
obtaining an angle to be rotated by the bi-section according to the normal vector of the starting point of the bi-section and the normal vectors of the two triangles related to the bi-section; and
obtaining two adjusted triangles according to the rotated angle of the bi-section.

20. The non-transitory computer-readable medium of claim 19, wherein the bi-section is rotated upward to an absolute value of the rotated angle of the bi-section corresponding to the plane of the two triangles related to the bi-section when the rotated angle of the bi-section is greater than zero, wherein the bi-section is rotated downward to the absolute value of the rotated angle of the bi-section corresponding to the plane of the two triangles related to the bi-section when the rotated angle of the bi-section is less than zero, and wherein the bi-section is kept unchanged when the rotated angle of the bi-section is equal to zero.
